(19) United States
(12) Patent Application Publication
(10) Pub. No.: US 2018/0151142 A1
(43) Pub. Date: May 31, 2018

(54) LCD TV, LCD PANEL, AND SHORT-CIRCUIT PROTECTION METHOD THEREOF

(71) Applicants: HISENSE ELECTRIC CO., LTD., Qingdao (CN); HISENSE USA CORPORATION, Suwanee, GA (US); HISENSE INTERNATIONAL CO., LTD., Qingdao (CN)

(72) Inventor: QINGHUA TIAN, QINGDAO (CN)

(21) Appl. No.: 15/589,831

(22) Filed: May 8, 2017

(30) Foreign Application Priority Data
Nov. 29, 2016 (CN) 201611076941.9

(51) Int. Cl. G09G 3/36; G02F 1/1362

(52) U.S. Cl. CPC G09G 3/3677; G02F 1/136204; G02F 1/136286; G09G 2300/0408; G09G 2310/0289; G09G 2330/04; G09G 2310/08

(57) ABSTRACT

Provided are an LCD TV, an LCD panel, and a short-circuit protection method thereof. The LCD panel includes a timing controller, a GOA signal controller and a panel main body, the GOA signal controller being connected to the panel main body via second circuit line. The GOA signal controller is used for shifting a level of received timing control signal outputted by the timing controller and sending level-shifted control signal to the panel main body, monitoring current of level-shifted control signal transmitted on second circuit line, and sending notification signal to the timing controller when current of level-shifted control signal exceeds a set threshold current. The timing controller is used for stopping outputting the timing control signal to the GOA signal controller when notification signal is captured, so that the GOA signal controller stops outputting level-shifted control signal. This application prevents risks resulted from short circuit in LCD panels.

### CROSS-REFERENCE TO RELATED APPLICATIONS

This application claims priority to Chinese Patent Application No. 201611076941.9, filed on Nov. 29, 2016, entitled “LCD PANEL AND SHORT-CIRCUIT PROTECTION METHOD THEREOF”, which is herein incorporated by reference in its entirety.

### TECHNICAL FIELD

This application relates to liquid crystal display (LCD) devices, and particularly, to an LCD TV, an LCD panel, and a short-circuit protection method thereof.

### BACKGROUND

Thanks to evolution of LCD panels and popularization of high resolution, large size and frameless technologies, demands are increasing for UHD GOA (ultra high definition gate on array) LCD panels. This has raised requirements on manufacturing process of UHD GOA LCD panels, and meanwhile increased the importance of designing back-end driving circuits to avoid certain undesirable faults. In related art, wiring for control line driving signals needs to be arranged on both sides of a UHD GOA LCD panel. Such wiring becomes denser for UHD GOA LCD panels of larger size and higher resolution. During the manufacturing process of UHD GOA LCD panels, foreign matter between the wirings in the UHD GOA LCD panels is likely to cause short circuit between adjacent wirings. Or, short circuit could occur between metal electrodes if the UHD GOA LCD panel fractures during use. Such short circuit can cause over temperature in the circuits, potentially overburning the polaroid.

### SUMMARY

On a first aspect, this application provides an LCD panel, including: a timing controller, a GOA signal controller and a panel main body, where the timing controller is connected to the GOA signal controller via a first circuit line, the GOA signal controller is connected to the panel main body via a second circuit line; the GOA signal controller is configured to: receive a timing control signal which is sent by the timing controller via the first circuit line, shift a level of the timing control signal, and send a level-shifted control signal to the panel main body via the second circuit line;

the GOA signal controller is further configured to monitor a current of the level-shifted control signal transmitted on the second circuit line, and send a notification signal to the timing controller when the current of the level-shifted control signal exceeds a set threshold current; and

the timing controller is configured to stop outputting the timing control signal to the GOA signal controller when the notification signal is captured, so that output of the GOA signal controller on the second circuit line is switched to a high impedance state, that is, the GOA signal controller stops outputting the level-shifted control signal.

On a second aspect, this application provides a short-circuit protection method of an LCD panel, the LCD panel including: a timing controller, a GOA signal controller and a panel main body, where the timing controller is connected to the GOA signal controller via a first circuit line, the GOA signal controller is connected to the panel main body via a second circuit line; the GOA signal controller is configured to: receive a timing control signal which is sent by the timing controller via the first circuit line, shift a level of the timing control signal, and send a level-shifted control signal to the panel main body via the second circuit line; where the method includes:

monitoring, by the GOA signal controller, a current of the level-shifted control signal transmitted on the second circuit line, and sending a notification signal to the timing controller when the current of the level-shifted control signal exceeds a set threshold current; and

stopping, by the timing controller, outputting the timing control signal to the GOA signal controller when the notification signal is captured, so that output of the GOA signal controller on the second circuit line is switched to a high impedance state, that is, the GOA signal controller stops outputting the level-shifted control signal.

On a third aspect, this application provides an LCD TV, including: a mainboard, an LCD panel which includes: a timing controller, a GOA signal controller and a panel main body, where the timing controller is connected to the GOA signal controller via a first circuit line, the GOA signal controller is connected to the panel main body via a second circuit line; the mainboard is configured to transmit an image signal to the timing controller; the timing controller is configured to generate a timing control signal according to the received image signal, and send the timing control signal to the GOA signal controller via the first circuit line; the GOA signal controller is configured to receive the timing control signal, shift a level of the timing control signal, and send a level-shifted control signal to the panel main body via the second circuit line;

the GOA signal controller is further configured to monitor a current of the level-shifted control signal transmitted on the second circuit line, and send a notification signal to the timing controller when the current of the level-shifted control signal exceeds a set threshold current; and

the timing controller is further configured to stop outputting the timing control signal to the GOA signal controller when the notification signal is captured, so that output of the GOA signal controller on the second circuit line is switched to a high impedance state, that is, the GOA signal controller stops outputting the level-shifted control signal.

### BRIEF DESCRIPTION OF DRAWINGS

FIG. 1 is a schematic block diagram illustrating an electrical principle of an LCD panel in related art;

FIG. 2 is a schematic block diagram illustrating an electrical principle of an LCD panel provided in some embodiments of this application;

FIG. 3 is a schematic block diagram illustrating an electrical principle of a GOA signal controller in an LCD panel provided in some embodiments of this application;

FIG. 4 is a schematic flowchart of a short-circuit protection method of an LCD panel provided in some embodiments of this application; and

FIG. 5 is a timing sequence chart of a short-circuit protection method of an LCD panel provided in some embodiments of this application.

### DETAILED DESCRIPTION

Now, the present application will be elaborated in further details in combination with accompanying drawings.

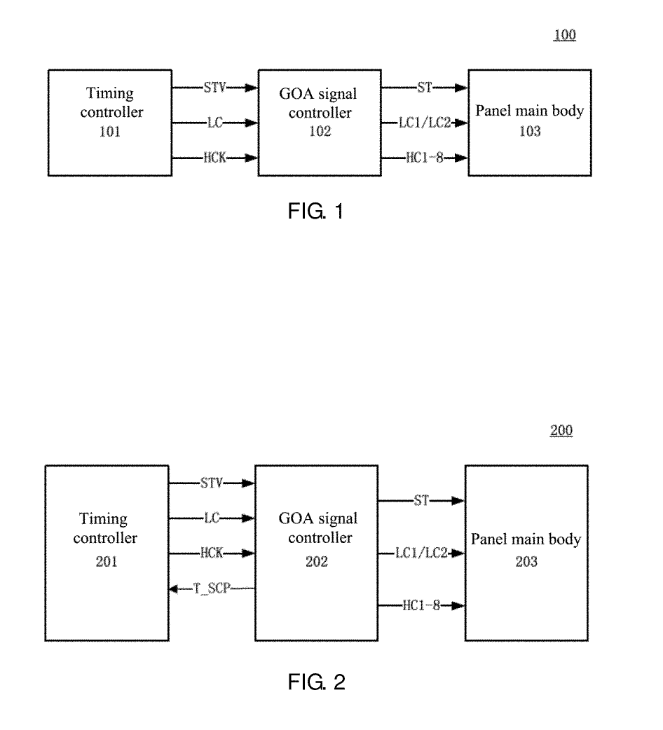

Since the presence of foreign matter cannot be absolutely prevented by merely controlling the manufacturing process of UHD GOA LCD panels, protective measures are practically required by the post-stage circuits for effectively decreasing damages to the circuits to offer protection. Referring to FIG. 1, a UHD GOA LCD panel 100 in related art includes: a timing controller 101, a GOA signal controller 102, and a panel main body 103 and the like. The timing controller 101 provides timing control signals STV, HCK and LC that are processed by the GOA signal controller 102 and then converted into control signals ST, HC1-8 and LC1/LC2, which are used for controlling the panel main body 103. The panel main body 103 (also referred to as a GOA unit) consists of TFT MOS devices of various sizes. The ST signal is an initiation signal of the GOA unit, and is used for controlling initiation actions of the GOA unit. The HC1-8 signal is a line control signal that primarily takes charge of the scanning and refreshing of each line of the GOA unit. The LC1/LC2 signal is a parity control signal that primarily controls each line of the GOA unit to always maintain the VSS voltage in order to prevent electric leakage from occurring.

A conventional short circuit protection design for the GOA circuits is achieved by adding a current-limiting resistance. That is, a current-limiting resistance of a certain value of resistance is inserted in series into the circuit line on which the control signals ST, HC1-8 and LC1/LC2 are outputted. As an example, the circuit line temperature may be above 110 degrees when no current-limiting resistance is added, and may drop to below 90 degrees after the current-limiting resistance is added.

Reference is now made to FIG. 2, which is a schematic block diagram illustrating an electrical principle of an LCD panel provided in some embodiments of this application. An LCD panel 200 proposed in this application includes: a timing controller 201, a GOA signal controller 202, and a panel main body 203. The timing controller 201 is connected to the GOA signal controller 202 via a first circuit line, and the GOA signal controller 202 is connected to the panel main body 203 via a second circuit line. The timing controller 201 is configured to generate a timing control signal according to a received image signal transmitted by a mainboard of an LCD TV, and send the timing control signal to the GOA signal controller 202 via the first circuit line. The GOA signal controller 202 is configured to receive the timing control signal which is sent by the timing controller 201 via the first circuit line, shift a level of the timing control signal, and send the level-shifted control signal to the panel main body 203 via the second circuit line. In this application, the level-shifted control signal includes, but is not limited to, signals ST, LC1/LC2 and HC1-8.

In this application, the GOA signal controller is further configured to monitor a current of the level-shifted control signal transmitted on the second circuit line, and send a notification signal to the timing controller when the current of the level-shifted control signal exceeds a set threshold current. The timing controller is configured to stop outputting the timing control signal to the GOA signal controller when the notification signal is captured, so that output of the GOA signal controller on the second circuit line is switched to a high impedance state, that is, the GOA signal controller stops outputting the level-shifted control signal.

Since a short circuit occurring on the second circuit line can cause the current of the level-shifted control signal transmitted on the circuit line to exceed the current limit for the output port of the GOA signal controller 202, the above described arrangement can enable the GOA signal controller 202 to provide a valid notification signal T_SCP, which is used for indicating over current on a circuit line, to the timing controller 201 when the current of the level-shifted control signal is determined to exceed a set threshold current. Thus, after capturing the valid notification signal T_SCP, the timing controller 201 can shut off, based on the valid notification signal T_SCP, the timing control signal outputted from the timing controller 201 to the GOA signal controller 202, and then cause the output from the GOA signal controller 202 to the second circuit line to switch to a high impedance state, and cause the GOA signal controller to stop outputting any current (i.e. stop outputting the level-shifted control signal), so as to reduce risks carried along with short circuit on the second circuit line. Those of ordinary skill in the art will appreciate that the aforementioned LCD panel may be a UHD GOA LCD panel, and may also be a GOA LCD panel with other resolutions.

In some embodiments of this application, as a possible implementation, the aforementioned timing controller 201 may further be provided with an over-current protection (OCP) unit. Hence, after capturing the valid notification signal T_SCP outputted from the GOA signal controller 202, the timing controller 201 can additionally begin from starting an over-current time count, and proceed to shut off the control signal outputted from the timing controller 201 to the GOA signal controller 202 when the over-current time count exceeds a set threshold time, so that the output from the GOA signal controller 202 to the second circuit line to switch to a high impedance state, that is, the GOA signal controller stops outputting the level-shifted control signal. In this case, the set threshold time can, for instance, be 20 microseconds. This approach causes the timing controller 201 to shut off the control signal outputted to the GOA signal controller 202 only after valid notification signals have been continuously captured by the timing controller 201 within a set threshold time duration, i.e., the current of the level-shifted control signal transmitted on the second circuit line has exceeded the current limit for the output port of the GOA signal controller 202 and remained in this state for the set threshold time, thereby improving the accuracy for the LCD panel in determining whether a short circuit has occurred on the second circuit line, reducing the possibility of misjudgment.

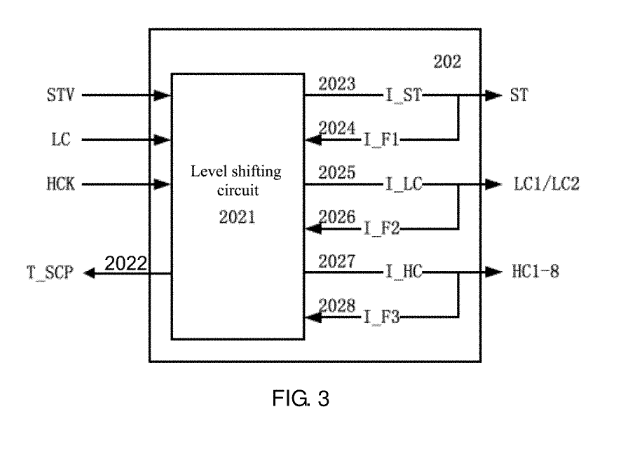

Reference is now made to FIG. 3, which is a schematic block diagram illustrating an electrical principle of a GOA signal controller in an LCD panel provided in some embodiments of this application. As a possible implementation, the GOA signal controller 202 can include a level-shifting circuit 2021. The level-shifting circuit 2021 is configured to perform processing, such as level shifting, on the timing control signal outputted from the timing controller 201, and output the level-shifted control signal to the second circuit line. The second circuit line may include multiple circuit lines, each for transmitting a different control signal. For example, in an implementation in which the timing controller 201 sends timing control signals STV, LC and HCK to the level-shifting circuit 2021, the aforementioned second circuit line may include three circuit lines (Line 1, Line 2 and Line 3). The level-shifting circuit 2021 can convert the timing control signal STV into ST and send the same to the panel main body 203 via Line 1, convert the timing control signal LC into LC1/LC2 and send the same to the panel main body 203 via Line 2, as well as convert the timing control signal HCK into HC1-8 and send the same to the panel main body 203 via Line 3, and so on.

As a possible implementation, the level-shifting circuit 2021 may, on a side facing the timing controller 201, be additionally provided with an output port 2022 for providing the notification signal T_SCP. It can be understood that the aforementioned timing controller 201 may internally include a microprocessor in which a program is run. The microprocessor may be provided with a dedicated detection port for detecting the notification signal T_SCP. For example, the microprocessor can capture the notification signal T_SCP by way of polling, or by way of interrupting.

On a side facing the panel main body 203, the level-shifting circuit 2021 may be provided with a port 2023 for outputting the signal ST. Under normal conditions, a line current I_ST provided by the port 2023 is of a fixed value, e.g. the line current I_ST is 20 milliamperes. The level-shifting circuit 2021 is provided with a port 2024 for acquiring the line current I_ST of the output signal ST of the port 2023, and providing a detection current I_F1 to the level-shifting circuit 2021. When the level-shifting circuit 2021 determines that the detection current I_F1 exceeds a set threshold current Iscp (e.g. 30 milliamperes), the output port 2022 of the level-shifting circuit 2021 can output the valid notification signal T_SCP to the timing controller 201.

Similarly, the level-shifting circuit 2021 is provided with a port 2025 for outputting the signal LC1/LC2. Under normal conditions, a line current I_LC provided by the port 2025 is of a fixed value, e.g. the line current I_LC is 20 milliamperes. The level-shifting circuit 2021 is provided with a port 2026 for acquiring the line current I_LC of the output signal LC1/LC2 of the port 2025, and providing a detection current I_F2 to the level-shifting circuit 2021. When the level-shifting circuit 2021 determines that the detection current I_F2 exceeds a set threshold current Iscp, the output port 2022 of the level-shifting circuit 2021 can output the valid notification signal T_SCP to the timing controller 201.

Similarly, the level-shifting circuit 2021 is provided with a port 2027 for outputting the signal HC1-8. Under normal conditions, a line current I_HC provided by the port 2027 is of a fixed value, e.g. the line current I_HC is 20 milliamperes. The level-shifting circuit 2021 is provided with a port 2028 for acquiring the line current I_HC of the output signal HC1-8 of the port 2027, and providing a detection current I_F3 to the level-shifting circuit 2021. When the level-shifting circuit 2021 determines that the detection current I_F3 exceeds a set threshold current Iscp, the output port 2022 of the level-shifting circuit 2021 can output the valid notification signal T_SCP to the timing controller 201.

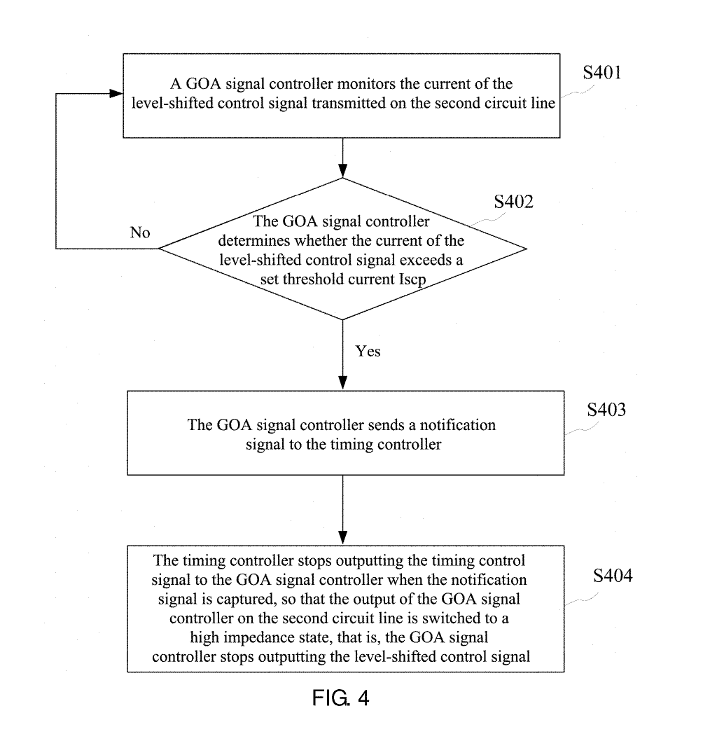

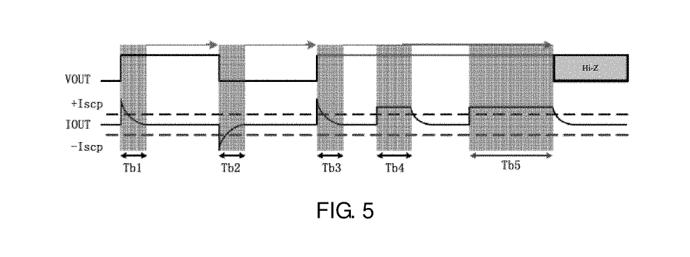

Reference is now made to FIGS. 4 and 5, where FIG. 4 is a schematic flowchart of a short-circuit protection method of an LCD panel provided in some embodiments of this application, and FIG. 5 is a timing sequence chart of a short-circuit protection method of an LCD panel provided in some embodiments of this application. A short-circuit protection method of an LCD panel provided in this application may include the following steps.

S401: A GOA signal controller monitors a current of a level-shifted control signal transmitted on a second circuit line.

S402: the GOA signal controller determines whether the current of the level-shifted control signal exceeds a set threshold current Iscp, and if yes, goes to step S403, if not, returns to step S401. In combination with FIG. 5, that is, the GOA signal controller determines whether the amplitude of the current IOUT on the second circuit line exceeds the set threshold current Iscp.

S403: the GOA signal controller sends a notification signal to the timing controller.

S404: the timing controller stops outputting the timing control signal to the GOA signal controller when the notification signal is captured, so that output of the GOA signal controller on the second circuit line is switched to a high impedance state, that is, the GOA signal controller stops outputting the level-shifted control signal.

As a possible implementation, when the notification signal is captured, the timing controller can further start an over-current time count and determine whether the over-current time count exceeds a set threshold time. If the over-current time count exceeds the set threshold time, stop outputting the timing control signal to the GOA signal controller. If the over-current time count does not exceed the set threshold time, return to step S401.

In combination with FIG. 5, it can be seen that, each time the GOA signal controller determines that the current of the level-shifted control signal exceeds the set threshold current Iscp and sends the notification signal to the timing controller, the timing controller will register a corresponding time count Tb1, Tb2, Tb3, Tb4, Tb5 and the like. Taking a set threshold time of 20 microseconds as an example, in this example, none of the time counts Tb1, Tb2, Tb3 or Tb4 exceeds the set threshold time, and only the time count Tb5 exceeds the set threshold time.

In combination with FIG. 5, when the second circuit line is in the normal condition (i.e., no short circuit occurs), the level VOUT of the level-shifted control signal outputted from the GOA signal controller to the second circuit line is a high level or a low level. Once entering into the short circuit protection state, that is, once the current of the level-shifted control signal transmitted on the second circuit line exceeds the set threshold current Iscp for a duration of time count Tb that exceeds the set threshold time, the timing controller will stop outputting the timing control signal to the GOA signal controller, so that the GOA signal controller stops outputting current IOUT to the second circuit line (that is, the GOA signal controller stops outputting the level-shifted control signal), i.e. the output of the GOA signal controller on the second circuit line will switch to a high impedance state.

It is worth mentioning that the time counts Tb1, Tb2 and Tb3 correspond to blanking time during which the current IOUT has a saltation that exceeds the set threshold current Iscp, which creates a current peak, but then returns to the normal state. The blanking time may be, for instance, 2 microseconds. The time count Tb4 corresponds to a situation in which the current IOUT exceeds the set threshold current Iscp and remains so for a time period, e.g. of 5 microseconds. Since the time count Tb4 has not lasted any longer than the aforementioned 20 microseconds set threshold time, the LCD panel will not enter into the short circuit protection state. That is, the timing controller is configured such that potential risks associated with panel protection mechanism being mis-triggered by current peaks can be effectively reduced.

Compared against related art, in this application, the GOA signal controller 202 monitors the current of the level-shifted control signal that is transmitted on the second circuit line, so that the GOA signal controller can determine whether the second circuit line is hit by short circuiting. Further, the GOA signal controller can send the notification signal to the timing controller when short circuit occurs on the second circuit line, so that the timing controller 201 can promptly shut off the timing control signal output of the timing controller 201 in case of short circuit occurring on the circuit lines, causing the output of the GOA signal controller 202 on the second circuit line to switch to the high impedance state and causing the GOA signal controller 202 to stop outputting the current, thereby effectively reducing potential risks to the GOA LCD panel from short circuit on the second circuit line.

This application further provides an LCD TV, including: a mainboard, an LCD panel that includes: a timing controller, a GOA signal controller and a panel main body, where the timing controller is connected to the GOA signal controller via a first circuit line, and the GOA signal controller is connected to the panel main body via a second circuit line. The mainboard is configured to transmit an image signal to the timing controller. The timing controller is configured to generate a timing control signal according to the received image signal, and send the timing control signal to the GOA signal controller via the first circuit line. The GOA signal controller is configured to receive the timing control signal, shift a level of the timing control signal, and send the level-shifted control signal to the panel main body via the second circuit line.

The GOA signal controller is further configured to monitor a current of the level-shifted control signal transmitted on the second circuit line, and send a notification signal to the timing controller when the current of the level-shifted control signal exceeds a set threshold current; and

the timing controller is further configured to stop outputting the timing control signal to the GOA signal controller when the notification signal is captured, so that output of the GOA signal controller on the second circuit line is switched to a high impedance state, that is, the GOA signal controller stops outputting the level-shifted control signal.

The LCD panel in the LCD TV of this embodiment can be any one of the LCD panels provided in the foregoing embodiments of this application, and can be configured to execute any one of the short-circuit protection methods of the LCD panel provided in the foregoing embodiments of this application by following similar principals which will not be repeated herein.

The foregoing content is merely some embodiments of this application, rather than used for limiting implementation solutions of this application. Those of ordinary skill in the art can, based on primary concepts and spirit of this application, readily make corresponding alterations or modifications. Therefore, the protection scope of this application shall be governed by the protection scope claimed by the accompanying claims.

What is claimed is:

1. A liquid crystal display (LCD) panel, comprising: a timing controller, a gate on array (GOA) signal controller and a panel main body, wherein the timing controller is connected to the GOA signal controller via a first circuit line, the GOA signal controller is connected to the panel main body via a second circuit line; the GOA signal controller is configured to: receive a timing control signal which is sent by the timing controller via the first circuit line, shift a level of the timing control signal, and send a level-shifted control signal to the panel main body via the second circuit line; wherein:
the GOA signal controller is further configured to: monitor a current of the level-shifted control signal transmitted on the second circuit line, and send a notification signal to the timing controller when the current of the level-shifted control signal exceeds a set threshold current; and
the timing controller is configured to stop outputting the timing control signal to the GOA signal controller when the notification signal is captured, so that the GOA signal controller stops outputting the level-shifted control signal.

2. The LCD panel according to claim 1, wherein the timing controller is configured to start an over-current time count when the notification signal is captured, and stop outputting the timing control signal to the GOA signal controller when the over-current time count exceeds a set time threshold.

3. The LCD panel according to claim 1, wherein the GOA signal controller comprises a level-shifting circuit, the level shifting circuit is configured to: shift the level of the timing control signal outputted by the timing controller, and output the level-shifted control signal to the second circuit line.

4. The LCD panel according to claim 1, wherein the timing control signal comprises an initiation signal, a line control signal and a parity control signal.

5. The LCD panel according to claim 1, wherein the timing controller comprises a microprocessor, the microprocessor is configured to capture the notification signal by way of polling or interrupting.

6. The LCD panel according to claim 2, wherein the set time threshold is 20 microseconds.

7. A short-circuit protection method of a liquid crystal display (LCD) panel, the LCD panel comprising: a timing controller, a gate on array (GOA) signal controller and a panel main body, wherein the timing controller is connected to the GOA signal controller via a first circuit line, the GOA signal controller is connected to the panel main body via a second circuit line, the GOA signal controller is configured to: receive a timing control signal which is sent by the timing controller via the first circuit line, shift a level of the timing control signal, and send a level-shifted control signal to the panel main body via the second circuit line; wherein the method comprises:
monitoring, by the GOA signal controller, a current of the level-shifted control signal transmitted on the second circuit line, and sending a notification signal to the timing controller when the current of the level-shifted control signal exceeds a set threshold current; and
stopping, by the timing controller, outputting the timing control signal to the GOA signal controller when the notification signal is captured, so that the GOA signal controller stops outputting the level-shifted control signal.

8. The LCD panel short-circuit protection method according to claim 7, wherein the stopping, by the timing controller, outputting the control signal to the GOA signal controller when the notification signal is captured comprises:
starting, by the timing controller, an over-current time count when the notification signal is captured, and stopping outputting the timing control signal to the GOA signal controller when the over-current time count exceeds a set time threshold.

9. The LCD panel short-circuit protection method according to claim 7, wherein the GOA signal controller comprises a level-shifting circuit for shifting a level of the timing control signal outputted by the timing controller and outputting the level-shifted control signal to the second circuit line.

10. The LCD panel short-circuit protection method according to claim 7, wherein the timing control signal comprises an initiation signal, a line control signal and a parity control signal.

11. The LCD panel short-circuit protection method according to claim 7, wherein the timing controller comprises a microprocessor for capturing the notification signal by way of polling or interrupting.

12. The LCD panel short-circuit protection method according to claim 8, wherein the set time threshold is 20 microseconds.

13. A liquid crystal display television (LCD TV), comprising: a mainboard, an LCD panel which comprises: a timing controller, a gate on array (GOA) signal controller and a panel main body, wherein the timing controller is connected to the GOA signal controller via a first circuit line, the GOA signal controller is connected to the panel main body via a second circuit line; the mainboard is configured to transmit an image signal to the timing controller; the timing controller is configured to generate a timing control signal according to the received image signal, and send the timing control signal to the GOA signal controller via the first circuit line; the GOA signal controller is configured to receive the timing control signal, shift a level of the timing control signal, and send a level-shifted control signal to the panel main body via the second circuit line; wherein:
the GOA signal controller is further configured to monitor a current of the level-shifted control signal transmitted on the second circuit line, and send a notification signal to the timing controller when the current of the level-shifted control signal exceeds a set threshold current; and
the timing controller is further configured to stop outputting the timing control signal to the GOA signal controller when the notification signal is captured, so that the GOA signal controller stops outputting the level-shifted control signal.
